(19) United States
(12) Patent Application Publication
(10) Pub. No.: US 2009/0154167 A1
(43) Pub. Date: Jun. 18, 2009

(54) MULTIPURPOSE LIGHT SOURCE

(76) Inventor: Jui-Li Lin, Wufong Hsiang (TW)

Correspondence Address: Hershkovitz & Associates, LLC, 2845 Duke Street, Alexandria, VA, 22314, US

(21) Appl. No.: 11/959,074

(22) Filed: Dec. 18, 2007

(51) Int. Cl. F21V 29/00; F21V 7/00

(52) U.S. Cl. 362/294; 362/310

(57) ABSTRACT

A multipurpose light source has at least one tubular assembly including a bracket, a light source, a light guide and a reflector. The light source may be a light emitting diode array or the like, being formed on the bracket. The light guide is pellucid and has a proximal end, a distal end and an annular surface. The proximal end of the light guide is mounted concentrically on the bracket adjacent to the light source and guides light emitted form the light source to the distal end. The reflector is formed in the distal end of the light guide and has a reflective surface being disposed obliquely to the light source and reflecting the output light to the annular surface.

### BACKGROUND OF THE INVENTION

1. Field of Invention

The present invention relates to a light source, and more particularly to a multipurpose light source.

2. Description of the Related Art

Light emitting diodes (LED) are currently replacing incandescent bulbs in many applications, because LEDs are more efficient and do not burn out quickly so are more environmentally friendly. However, one LED is not sufficient for lighting a whole room, so an LED array for increased brightness and lighting area is frequently implemented. LED arrays can be applied to flashlights, vehicle lamps, traffic signals or the like. However, applications of LED arrays are limited because the LED array is a surface light source and cannot be used to replace fluorescent tubes or lamps.

The present invention provides a multipurpose light source to obviate or mitigate the limitations when using LEDs for interior lighting.

### SUMMARY OF THE INVENTION

The primary objective of the present invention is to provide a multipurpose light source using a surface light source or a point light source to generate a broadly output light such as that emitted from a fluorescent tube or a fluorescent lamp.

The multipurpose light source comprises at least one tubular assembly comprising a bracket, a light source, a light guide and a reflector. The light source may be a light emitting diode array or the like, being formed on the bracket. The light guide is pellucid and has a proximal end, a distal end and an annular surface. The proximal end of the light guide is mounted concentrically on the bracket adjacent to the light source and guides light emitted form the light source to the distal end. The reflector is formed on the distal end of the light guide and has a reflective surface being disposed obliquely to the light source and reflecting the output light to the annular surface.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a multipurpose light source in accordance with the present invention;

FIG. 2 is a partially exploded perspective view of the multipurpose light source in FIG. 1;

FIG. 3 is a perspective view of a second embodiment of a multipurpose light source in accordance with the present invention;

FIG. 4 is an exploded perspective view of the multipurpose light source in FIG. 3;

FIG. 5 is a perspective view of a third embodiment of a multipurpose light source in accordance with the present invention;

FIG. 6 is a perspective view of a forth embodiment of the multipurpose light source in accordance with the present invention;

FIG. 7 is a partially exploded perspective view of the multipurpose light source in FIG. 6; and

FIG. 8 is a cross-sectional perspective view of a fifth embodiment of a multipurpose light source in accordance with the present invention.

### DETAILED DESCRIPTION OF THE INVENTION

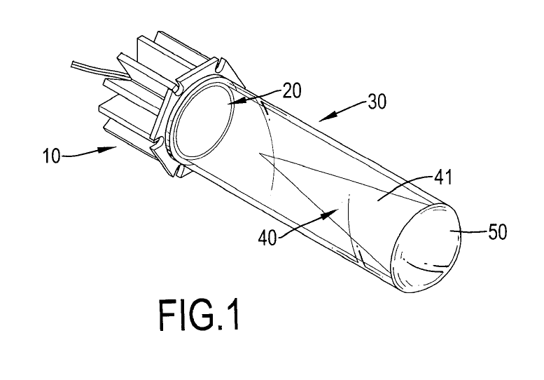

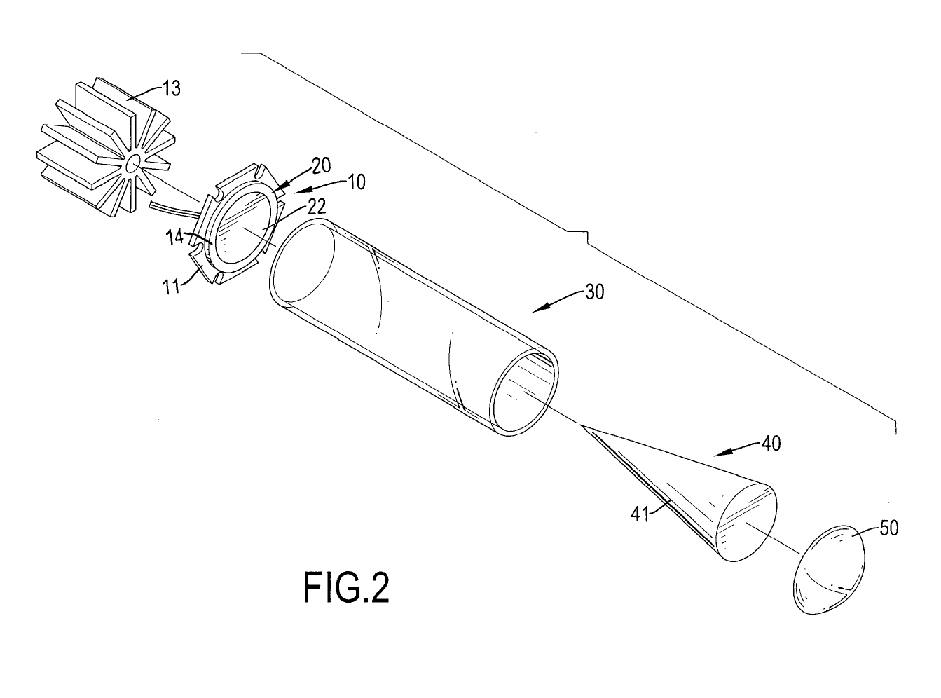

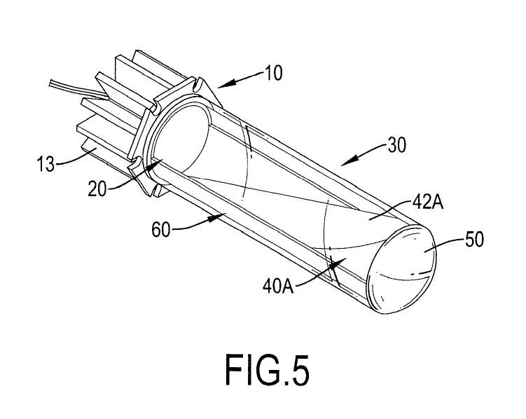

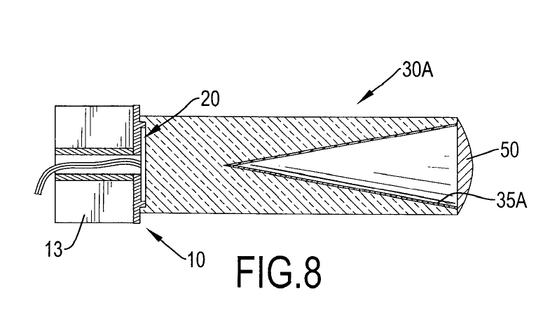

With reference to FIGS. 1, 2, 5 and 8, a multipurpose light source in accordance with the present invention comprises at least one tubular assembly. Each tubular assembly comprises a bracket (10), a source (20), a light guide (30, 30A), a reflector (40, 40A), an optional cover (50) and an optional assistant reflector (60).

The bracket (10) is thermally conductive, may be metal such as Copper or Aluminum, has a light source base (11) and may have a heat sink (13).

The light source base (11) has a front surface, a rear surface and may have a light source mount (14). The light source mount (14) is annular, is formed on and protrudes concentrically from the front surface of the light source base (11).

The heat sink (13) is mounted on the rear surface of the light source base (11).

The light source (20) may be a point light source or a surface light source, may be a light emitting diode (LED), an LED array or a Xenon lamp, corresponds to and is mounted on the front surface of the light source base (11), may be mounted inside the light source mount (14) and has a radiating surface (22). The radiating surface (22) radiates an output light.

The light guide (30, 30A) is pellucid, may be a hollow tube (30) or a solid cylinder (30A) and has a proximal end, a distal end, a length, an annular surface, may have an inner surface to guide output light of the radiating surface from the proximal end to the distal end. The proximal end corresponds to the light source (20), is detachably mounted concentrically on the front surface of the light source base (11), may correspond to and be detachably mounted concentrically around the light source mount (14).

The reflector (40, 40A) may be a cone or a cant-cut cylinder, is formed in the distal end of and disposed through the light guide (30A) may be shorter than or have a same length as the light guide (30, 30A) and has a reflecting surface (41). The reflecting surface is reflective, disposed obliquely to the light source (30) to reflect the output light toward the annular surface to form divergent light. The reflector may (40, 40A) be mounted in the light guide (30).

The cover (50) corresponds to the distal end of the light guide (20), may be disc-like, and is detachably mounted on the distal end of the light guide (20) to fasten the reflector (40) mounted inside the light guide (30) or to decoratively cover the reflecting recess (35A).

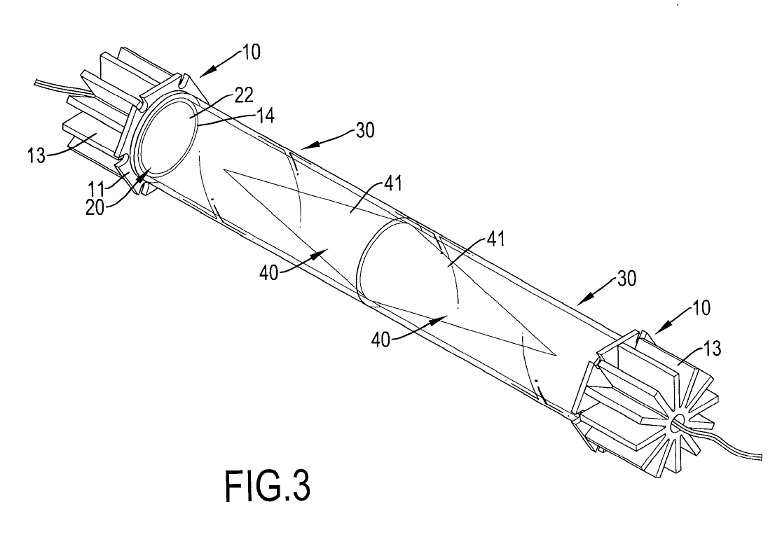

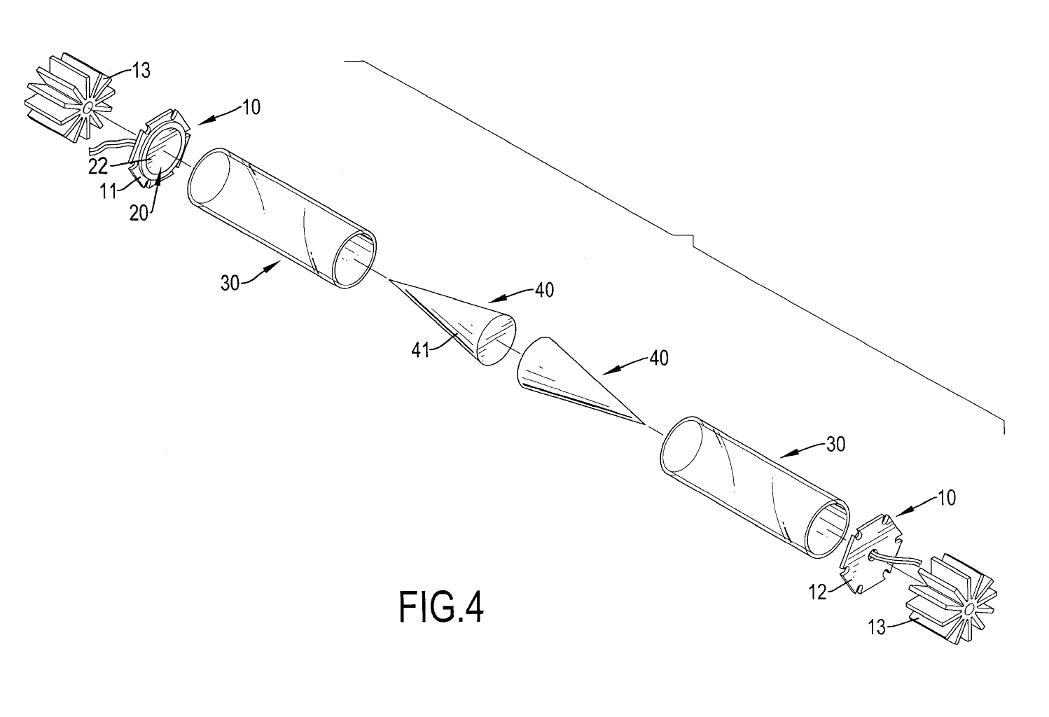

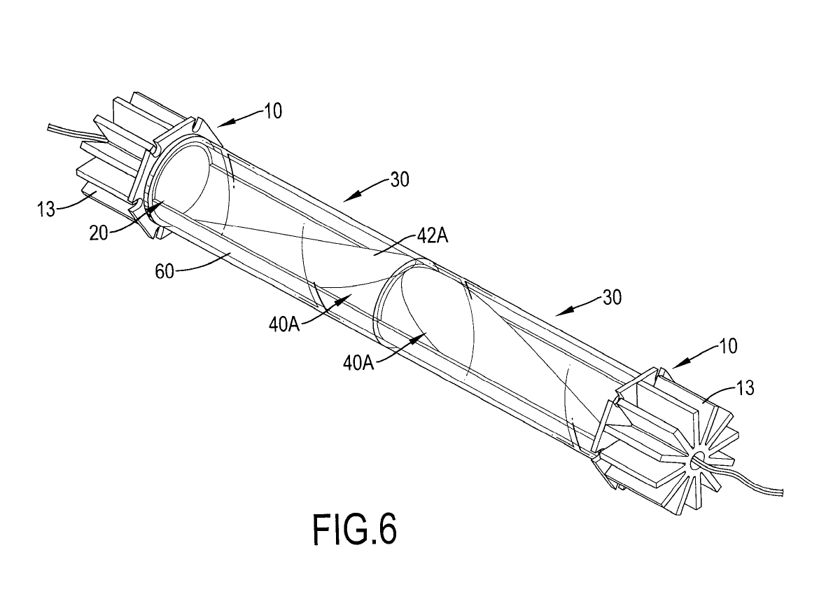

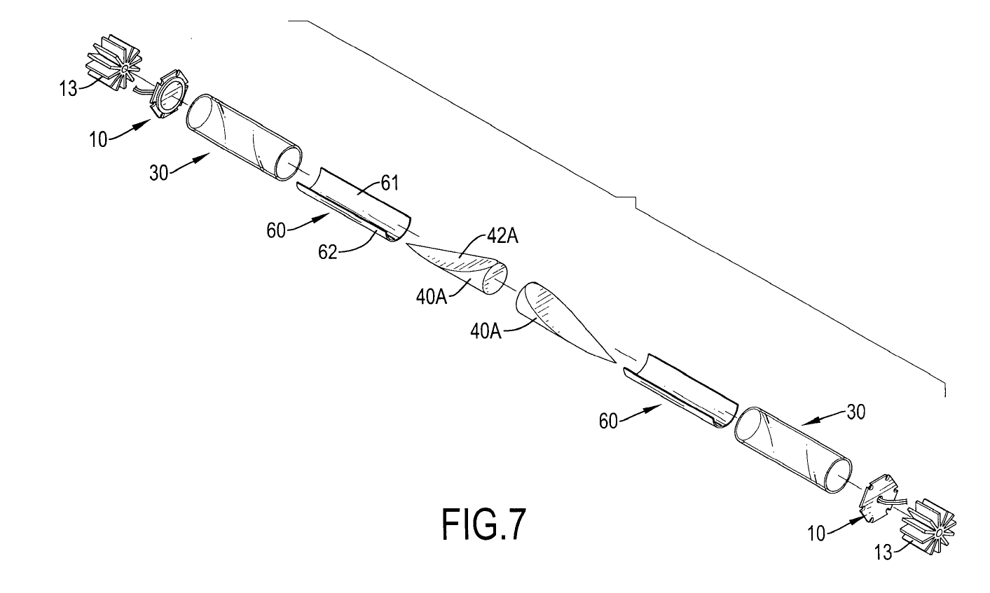

With further reference to FIGS. 3, 4, 6 and 7, two tubular assemblies may be implemented, being symmetrically mounted concentrically, with the distal ends of the light guides (30) disposed adjacent to one another to form a tubular ruminant capable of replacing a conventional fluorescent tube.

When reflector (40A) is implemented as the cant-cunt cylinder, the assistant reflector (60) is an arced sheet corresponding to the light guide (30) and mounted between the light guide (30) and the reflector (40A) and has an outer surface (62) and an inner surface (61). The outer surface (62) is attached to the inner surface of the light guide (30). The inner surface (61) is reflective, and reflects output light from the light source (20) toward the annular surface of the light guide (30).

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A multipurpose light source comprising:
a bracket being thermally conductive and having
a light source base having
a front surface; and
a rear surface;
a light source corresponding to and being mounted on the front surface of the light source base and having a radiating surface radiating output light;
a light guide being pellucid and having
a proximal end corresponding to the light source and being detachably mounted concentrically on the front surface of the light source base;
a distal end;
a length; and
an annular surface; and
a reflector being formed in the distal end of and disposed through the light guide and having
a reflecting surface being reflective and disposed obliquely to the light.

2. The multipurpose light source as claimed in claim 1, wherein the light source is a light emitting diode (LED).

3. The multipurpose light source as claimed in claim 1, wherein the light source is an LED array.

4. The multipurpose light source as claimed in claim 1, wherein the light source is a Xenon lamp array.

5. The multipurpose light source as claimed in claim 1, wherein the bracket has a heat sink being mounted on the rear surface of the light source base.

6. The multipurpose light source as claimed in claim 5, wherein the light guide is a hollow tube and has an inner surface.

7. The multipurpose light source as claimed in claim 6, wherein
the reflector is a cone being mounted in the light guide and being shorter than the length of the light guide.

8. The multipurpose light source as claimed in claim 6, wherein
the reflector is a cant-cut cylinder being mounted inside the light guide; and
each tubular assembly further has an assistant reflector being an arc sheet partially corresponding to the light guide, being mounted between the light guide and the reflector and having
an outer surface being attached to the inner surface of the light guide; and
an inner surface being reflective.

9. The multipurpose light source as claimed in claim 5, wherein the light guide is a solid cylinder.

10. The multipurpose light source as claimed in claim 7, wherein the tubular assembly further has a cover being disc-like, corresponding to and being mounted on the distal end of the lighting guide.

11. The multipurpose light source as claimed in claim 8, the tubular assembly further has a cover being disc-like, corresponding to and being mounted on the distal end of the lighting guide.

12. The multipurpose light source as claimed in claim 9, the tubular assembly further has a cover being disc-like, corresponding to and being mounted on the distal end of the lighting guide.

13. The multipurpose light source as claimed in claim 1, wherein
the light source base further has a light source mount being annular and being formed on and protruding concentrically from the front surface of the light source base;
the light source is mounted inside the light source mount; and
the light guide corresponds to and is mounted concentrically around the light source mount.

14. A multipurpose light source comprising two tubular assemblies, each one of the tubular assembly comprising:
a bracket being thermally conductive and having
a light source base having
a front surface; and
a rear surface;
a light source corresponding to and being mounted on the front surface of the light source base and having a radiating surface radiating output light;
a light guide being pellucid and having
a proximal end corresponding to the light source and being detachably mounted concentrically on the front surface of the light source base;
a distal end;
a length; and
an annular surface;
a reflector being formed in the distal end of and disposed through the light guide and having
a reflecting surface being reflective and disposed obliquely to the light; and
wherein, the tubular assemblies are implemented being symmetrically mounted concentrically with the distal ends of the light guides disposed adjacent to one another.

15. The multipurpose light source as claimed in claim 14, wherein the bracket has a heat sink being mounted on the rear surface of the light source base.

16. The multipurpose light source as claimed in claim 15, wherein the light guide is a hollow tube and has an inner surface.

17. The multipurpose light source as claimed in claim 6, wherein
the reflector is a cone being mounted in the light guide and being shorter than the length of the light guide.

18. The multipurpose light source as claimed in claim 6, wherein
the reflector is a cant-cut cylinder being mounted inside the light guide; and
each tubular assembly further has an assistant reflector being an arc sheet partially corresponding to the light guide, being mounted between the light guide and the reflector and having
an outer surface being attached to the inner surface of the light guide; and
an inner surface being reflective.

19. The multipurpose light source as claimed in claim 5, wherein the light guide is a solid cylinder.
